(19) United States
(12) Patent Application Publication
(10) Pub. No.: US 2026/0155533 A1
(43) Pub. Date: Jun. 4, 2026

(54) Busbar Assembly, Assembling Method for Battery Cells By Using Same, and Battery Pack Including Same

(71) Applicant: SK On Co., Ltd., Seoul (KR)

(72) Inventors: Won-Seok JEONG, Daejeon (KR); Hae-Ryong JEON, Daejeon (KR)

(21) Appl. No.: 19/122,331

(22) PCT Filed: May 9, 2023
(86) PCT No.: PCT/KR2023/006286

§ 371 Date: Apr. 18, 2025

(30) Foreign Application Priority Data
Jan. 17, 2023 (KR) 10-2023-0006777

(51) Int. Cl. H01M 50/503; H01M 50/15; H01M 50/176; H01M 50/209; H01M 50/244; H01M 50/507

(52) U.S. Cl. CPC H01M 50/503; H01M 50/15; H01M 50/176; H01M 50/209; H01M 50/244; H01M 50/507

(57) ABSTRACT

A battery pack according to an embodiment of this invention may comprise: a plurality of battery cells including electrode terminals on one side of a case; a cell fixing plate to which the plurality of battery cells are coupled; and a busbar assembly electrically connected to the plurality of battery cells, wherein the cell fixing plate may be arranged under the plurality of battery cells, and the busbar assembly may be arranged under the cell fixing plate.

### CROSS-REFERENCE TO RELATED APPLICATIONS

This application is a National Stage Entry of International Patent Application No. PCT/KR2023/006286, filed May 9, 2023, which claims the benefit of priority to Korean Patent Application No. KR 10-2023-0006777, filed Jan. 17, 2023, each of which is incorporated by reference in its entirety for all purposes.

### TECHNICAL FIELD

The present disclosure relates to a busbar assembly, an assembling method for battery cells by using the same, and a battery pack including the same.

### BACKGROUND ART

Secondary batteries are batteries capable of being repeatedly charged with, or discharged of, electricity therein or therefrom because the mutual conversion between chemical energy and electrical energy is reversible.

Such secondary batteries may be used as energy sources for mobile devices, as well as electric vehicles, hybrid vehicles, and energy storage systems (ESS), which have been attracting attention recently.

Secondary batteries may be used in the form in which one or more battery cells are electrically connected, the one or more battery cells being manufactured as flexible pouch-shaped battery cells or rigid square or cylindrical can-shaped battery cells. Specifically, electric vehicles requiring high-power characteristics, and the like, may be used in the form of a battery module in which one or more cell stacks having multiple battery cells stacked therein are electrically connected, or in the form in which one or more battery modules are electrically connected.

Recently, a cell-to-pack method, in which one or more battery cells do not form a battery module but form a battery pack directly, has attracted attention. Since the cell-to-pack method omits the battery module, this has the advantage of reducing the number of components and a dead space, thereby improving energy density.

Meanwhile, a plurality of battery cells assembled in a cell-to-pack method are attached to a bottom surface of a pack housing by an adhesive or tape. However, since the battery cells cannot be firmly fixed to the pack housing by the tape or the like, there is a problem that the battery cells may easily move due to external impact or vibration.

### SUMMARY OF INVENTION

### Technical Problem

The present disclosure is to provide a busbar assembly capable of easily electrically connecting battery cells, an assembling method for battery cells using the same, and a battery pack including the same.

### Solution to Problem

A battery pack according to the present disclosure may include: a plurality of battery cells including electrode terminals on one side of a case; a cell fixing plate to which the plurality of battery cells are coupled; and a busbar assembly electrically connected to the plurality of battery cells, wherein the cell fixing plate is disposed below the plurality of battery cells, and the busbar assembly is disposed below the cell fixing plate.

According to the present disclosure, the busbar assembly may include: a plurality of busbars electrically connected to the electrode terminals; a busbar plate on which the plurality of busbars are disposed; and a spring elastically supporting the plurality of busbars.

According to the present disclosure, the busbar assembly may include: a fitting groove to which the electrode terminal is coupled; and an extension portion extending in a longitudinal direction or a widthwise direction of the busbar plate, based on the fitting groove.

According to the present disclosure, the electrode terminal may include a fitting protrusion inserted into the fitting groove, and the plurality of battery cells are electrically connected to the plurality of busbars as the fitting protrusion is coupled to the fitting groove.

According to the present disclosure, the fitting protrusion may have a semicircular cross-sectional shape.

According to the present disclosure, the spring may be one of a compression spring or a plate spring.

According to the present disclosure, the cell fixing plate may include: a base; and a plurality of coupling holes formed in the base, including a first hole into which a cathode terminal, among the electrode terminals, is inserted and a second hole into which an anode terminal, among the electrode terminals, is inserted, wherein the first hole and the second hole may include a first portion having a first width and a second portion having a second width narrower than the first width.

According to the present disclosure, the busbar assembly may be disposed so that the extension portion faces the first portion and the fitting groove faces the second portion.

According to the present disclosure, the plurality of battery cells may include a cap plate coupled to one side of the case and provided with the electrode terminal; and a separation protrusion separating one surface of the electrode terminal from the cap plate, wherein the electrode terminal may be formed to have a width not wider than the first width, and the separation protrusion may be formed to have a width equal to the second width.

According to the present disclosure, the plurality of battery cells may include a cap plate coupled to one side of the case and provided with the electrode terminal; and a coupling protrusion formed on one side of the cathode terminal and one side of the anode terminal, respectively, and penetrating through the first hole and the second hole, and wherein the coupling protrusion may include a portion formed to have a width not wider than the first width and a portion formed to have a width equal to the second width.

A busbar assembly according to an embodiment of the present disclosure may include: a plurality of busbars disposed at a bottom plate of the pack housing, and electrically connected to electrode terminals of a plurality of battery cells; a busbar plate on which the plurality of busbars are disposed; and a spring elastically supporting the plurality of busbars.

According to an embodiment of the present disclosure, the plurality of busbars may include: a fitting groove to which the electrode terminal is fitted; and an extension portion extending in a longitudinal direction or a widthwise direction of the busbar plate based on the fitting groove.

An assembling method for battery cells according to an embodiment of the present disclosure may include: a vertical movement operation of vertically moving a cell group comprised of a plurality of battery cells toward a cell fixing plate and a busbar assembly disposed below the cell fixing plate and including a plurality of busbars; and a horizontal movement operation of horizontally moving or rotating the cell group on the cell fixing plate and the busbar assembly so that the plurality of battery cells are fixed to the cell fixing plate and the busbar assembly.

According to an embodiment of the present disclosure, the electrode terminal may include a fitting protrusion, and the plurality of busbars may include a fitting groove having a shape corresponding to the fitting protrusion, and in the horizontal movement operation, the fitting protrusion may be inserted into the fitting groove.

According to an embodiment of the present disclosure, the cell fixing plate may include a plurality of coupling holes into which the electrode terminal is inserted, and which include a first portion having a first width and a second portion having a second width narrower than the first width, and in the horizontal movement operation, the electrode terminal may be moved from the first portion side to the second portion side.

According to an embodiment of the present disclosure, the battery cell may include: a cap plate coupled to one side of the case and provided with the electrode terminal; and a separation protrusion separating one surface of the electrode terminal from the cap plate, wherein the electrode terminal may be formed to have a width not wider than the first width, and the separation protrusion may be formed to have a width equal to the second width.

According to an embodiment of the present disclosure, the plurality of busbars may include an extension portion extending to one side based on the fitting groove, and the extension portion may be disposed to face the first portion, and the fitting groove may be disposed to face the second portion.

According to an embodiment of the present disclosure, when the second portion of the first hole and the second portion of the second hole are formed to be oriented in the same direction, and the fitting grooves of the busbar are formed to be oriented in the same direction, in the horizontal movement operation, the cell group may be moved in parallel on the cell fixing plate and the busbar assembly.

According to an embodiment of the present disclosure, when the second portion of the first hole and the second portion of the second hole are formed to be oriented in different directions, and the busbar facing the first hole and the busbar facing the second hole may be disposed to be oriented in different directions, in the horizontal movement operation, the cell group may be rotated on the cell fixing plate and the busbar assembly.

### Advantageous Effects of Invention

According to an embodiment of the present disclosure, a battery cell may be electrically connected to a busbar without a separate welding process. Additionally, since the battery cell is electrically connected to the busbar while being coupled to the cell fixing plate, the assembly process may be simplified.

### BRIEF DESCRIPTION OF DRAWINGS

FIG. 1 is an exploded perspective view of a cell fixing plate and a busbar assembly in which a battery cell is assembled according to an embodiment of the present disclosure;

FIG. 2 is a view illustrating a state in which a battery cell is assembled to a cell fixing plate according to an embodiment of the present disclosure.

FIG. 3 is a rear view of FIG. 2.

FIG. 4 is a perspective view of a cell fixing plate according to an embodiment of the present disclosure.

FIG. 5 is a perspective view of a battery cell according to an embodiment of the present disclosure.

FIG. 6 is a side view of the battery cell of FIG. 5.

FIGS. 7A and 7B are views illustrating a method of assembling a battery cell to a cell fixing plate according to an embodiment of the present disclosure.

FIG. 8 is a cross-sectional side view of a busbar assembly according to an embodiment of the present disclosure.

FIGS. 9A and 9B are views illustrating a method of assembling a battery cell to a busbar assembly according to an embodiment of the present disclosure.

FIG. 10 is a perspective view of a battery cell according to another embodiment of the present disclosure.

FIGS. 11A and 11B are views illustrating an assembling method for a battery cell to a cell fixing plate according to another embodiment of the present disclosure.

FIGS. 12A and 12B are perspective views of a busbar assembly according to another embodiment of the present disclosure.

### BEST MODE FOR INVENTION

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

The same reference numeral or symbol written in each accompanying drawing of the specification refers to parts or components that perform substantially the same function. The present inventive concept is described using the same reference numeral or symbol even in different exemplary embodiments for easy description and appreciation. In this aspect, although all components having the same reference numeral are illustrated in a plurality of drawings, the plurality of drawings do not necessarily refer to a single exemplary embodiment.

In this specification, the singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof.

Additionally, it should be noted in advance that the expressions such as “above,” “upper,” “below”, “beneath,” “lower,” “side,” “front,” and “rear” are based on the directions illustrated in the drawings, and may be expressed differently if the direction of the object is changed.

Additionally, it will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Hereinafter, embodiments of the present invention will be described with reference to the attached drawings.

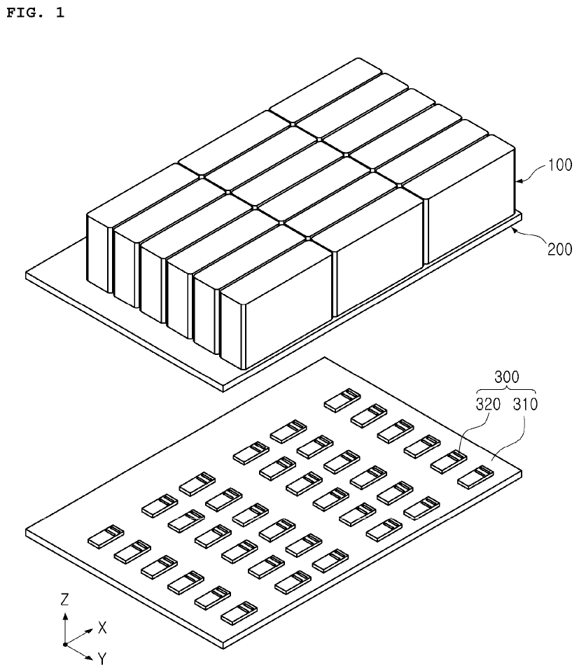

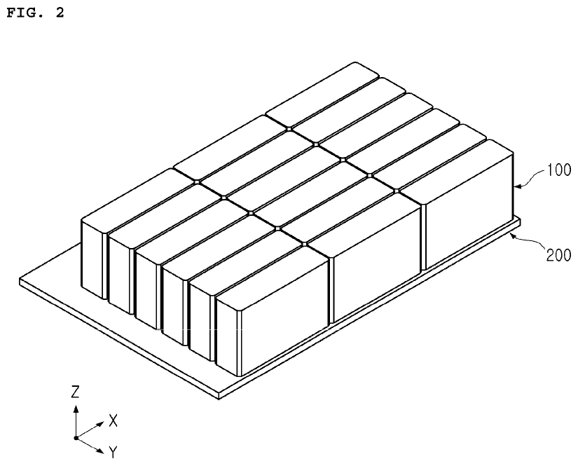

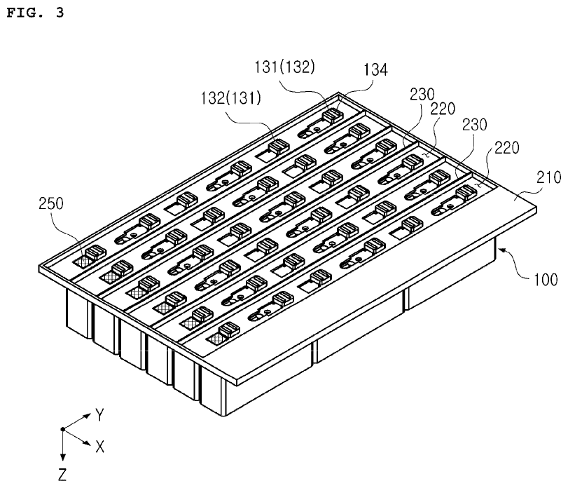

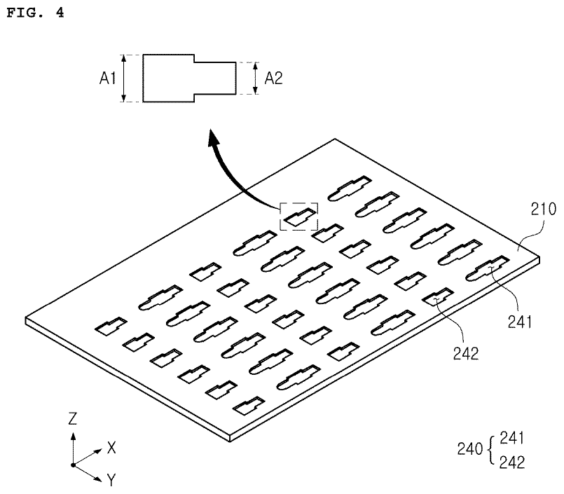

FIG. 1 is an exploded perspective view of a cell fixing plate and a busbar assembly in which a battery cell is assembled according to an embodiment of the present disclosure, FIG. 2 is a view illustrating a state in which a battery cell is assembled to a cell fixing plate according to an embodiment of the present disclosure, FIG. 3 is a rear view of FIG. 2, and FIG. 4 is a perspective view of a cell fixing plate according to an embodiment of the present disclosure.

According to an embodiment of the present disclosure, a battery cell 100 may be disposed in a battery pack (not illustrated) in a state in that the battery cell 100 is assembled to a cell fixing plate 200. Furthermore, the battery cell 100 may be assembled to a busbar assembly 300 together with the cell fixing plate 200. That is, the battery pack according to an embodiment of the present disclosure may include a structure illustrated in FIG. 1 inside the pack housing.

According to an embodiment of the present disclosure, the cell fixing plate 200 may be disposed in a pack housing of the battery pack. For example, the cell fixing plate 200 may be disposed in a bottom plate (not illustrated) forming a bottom surface of the battery pack. The cell fixing plate 200 may be one of several components forming the pack housing.

A plurality of battery cells 100 may be disposed in the cell fixing plate 200. The plurality of battery cells 100 may be disposed in a matrix form in a longitudinal direction (or X-direction) and a widthwise direction (or Y-direction) of the cell fixing plate 200.

The cell fixing plate 200 may include a base 210, a guide groove 220, a partition wall 230, and a coupling hole 240. The guide groove 220, the partition wall 230, and the coupling hole 240 may all be provided in the base 210.

The guide groove 220 and the partition wall 230 may be provided on an opposite surface of a surface on which the battery cells 100 are disposed. For example, the guide groove 220 and the partition wall 230 may be provided on a bottom surface of the base 210. The guide groove 220 and the partition wall 230 may be provided alternately in a widthwise direction of the base 210. A gap between two adjacent partition walls 230 in the widthwise direction of the base 210 may be a width of the guide groove 220, and for example, the width of the guide groove 220 may be approximately the same as a width of the battery cell 100. Accordingly, the battery cell 100 may be fixedly aligned to the guide groove 220.

The partition walls 230 may be alternately disposed with the guide grooves 220 to separate adjacent guide grooves 220. Accordingly, the battery cells 100 aligned to different guide grooves 220 may be spatially and thermally separated at least on one side thereof. For example, a space separated by the partition walls 230 may be filled with air (e.g., an air gap), and heat transfer between the battery cells 100 aligned to different guide grooves 220 may be blocked and delayed.

The coupling hole 240 is a hole penetrating through the base 210 in a thickness direction, and the battery cell 100 may be fixed to the base 210 through the coupling hole 240. For example, the battery cell 100 may be fixed to the base 210 in a state in which electrode terminals 131 and 132 are disposed to pass through the coupling hole 240.

The coupling hole 240 may be formed to have a predetermined interval in a longitudinal direction of the guide groove 220 on the base 210 (which is the same as the longitudinal direction of the base 210). Referring to FIG. 4, the coupling hole 240 may include a first hole 241 and a second hole 242 having different shapes, and the first hole 241 and the second hole 242 may be formed alternately in the longitudinal direction of the guide groove 220.

Before describing a detailed description of the coupling hole 240, the battery cell 100 will be described.

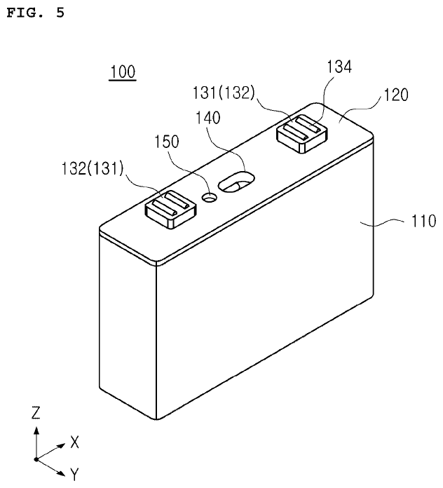

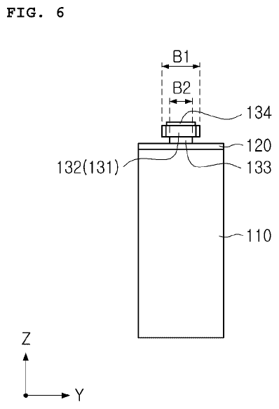

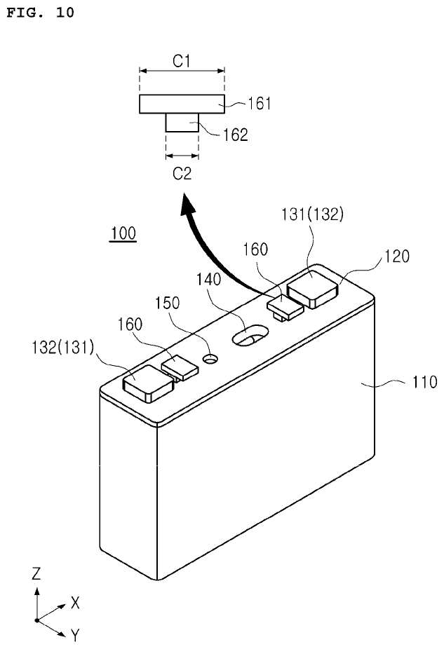

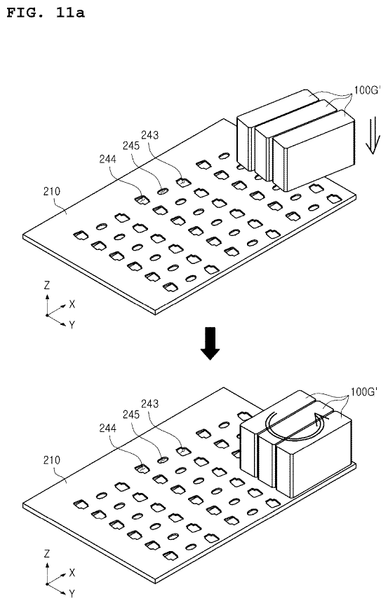

FIG. 5 is a perspective view of a battery cell according to an embodiment of the present disclosure, FIG. 6 is a side view of the battery cell of FIG. 5, and FIG. 10 is a perspective view of a battery cell according to another embodiment of the present disclosure.

The battery cell 100 disposed on the cell fixing plate 200 may be a square battery cell as illustrated in FIG. 5. The square battery cell may refer to a battery cell in which a case 110 including an electrode assembly and an electrolyte has a flat and square shape.

A cap plate 120 may be coupled to one side of the case 110. The cap plate 120 may be provided with electrode terminals 131 and 132 and a venting portion 140. Additionally, an electrolyte injection port 150 for injecting an electrolyte into an inside of the case 110 may also be provided.

The battery cells 100 disposed adjacently in the battery pack may be electrically connected through electrode terminals 131 and 132 (more specifically, through a busbar connected to the electrode terminals). The electrode terminals 131 and 132 may include a cathode terminal 131 and an anode terminal 132, and the cathode terminal 131 and the anode terminal 132 may be spaced apart from each other in the longitudinal direction on the cap plate 120. Additionally, the venting portion 140 described above may be provided between the cathode terminal 131 and the anode terminal 132.

Referring to FIG. 5, a separation protrusion 133 separating a wide surface of the electrode terminals 131 and 132 from the cap plate 120 may be formed between the electrode terminals 131 and 132 and the cap plate 120. The separation protrusion 133 may be a portion of the electrode terminals 131 and 132 or may be a portion of an insulating plate (not illustrated) disposed between the electrode terminals 131 and 132 and the cap plate 120.

In detail, the case 110 and the cap plate 120 of the square battery cell may be formed of a material including aluminum, and accordingly, the case 110 and the cap plate 120 themselves may have a positive electrode. Accordingly, the cathode terminal 131 may be designed to be in direct contact with the cap plate 120, but an insulating plate should be disposed between the anode terminal 132 and the cap plate 120 to electrically insulate the anode terminal 132 from the cap plate 120. Accordingly, the separation protrusion 133 illustrated in FIG. 5 may be a portion of the cathode terminal 131 or a portion of the insulating plate disposed between the anode terminal 132 and the cap plate 120.

Referring to FIG. 6, the electrode terminals 131 and 132 may have a first width B1, and the separation protrusion 133 may have a second width B2 narrower than the first width B1. Accordingly, when viewed in the longitudinal direction (or X-direction), portions of the electrode terminals 131 and 132 may have a ‘T-shaped’ cross-section.

The separation protrusion 133 may be formed to have a second width B2 narrower than that of the electrode terminals 131 and 132 in order to secure the battery cell 100 to the base 210, and a detailed description thereof will be described below.

Additionally, referring to FIG. 5, the electrode terminals 131 and 132 may include a fitting protrusion 134. Each of the electrode terminals 131 and 132 may include two fitting protrusions 134. For example, the fitting protrusions 134 may have a curved surface, preferably a semicircular shape. The fitting protrusions 134 may be spaced apart from each other in the longitudinal direction (or X-direction) of the battery cell 100 on the electrode terminals 131 and 132. The fitting protrusions 134 may be a portion electrically connected to a busbar 320 of the busbar assembly 300, and a detailed description thereof will be described later.

Meanwhile, in this specification, an embodiment in which the battery cell 100 is fixed to the base 210 in a state in which the electrode terminals 131 and 132 are disposed to pass through the coupling holes 240 is mainly described, but, as illustrated in FIG. 10, the battery cell 100 may include a separate configuration fixed to the coupling holes 240.

Referring to FIG. 10, the battery cell 100 may include a coupling protrusion 160 fixed to the coupling holes 240 instead of the electrode terminals 131 and 132. The coupling protrusion 160 may include a portion having a first width C1 and a portion having a second width C2, similarly to the electrode terminals 131 and 132 in the above-described embodiment, and may instead be formed of an insulating material.

The coupling protrusion 160 may be provided on the cap plate 120 together with the electrode terminals 131 and 132. The coupling protrusions 160 may be provided on one side of the cathode terminal 131 and one side of the anode terminal 132, respectively. In an embodiment, the coupling protrusion 160 may be provided on an inner side of the electrode terminals 131 and 132 based on the venting portion 140 disposed in a central portion of the cap plate 120, as illustrated in FIG. 10. However, a position of the coupling protrusion 160 is not particularly limited as long as the coupling protrusions 160 are provided on both sides based on the venting portion 140, respectively. That is, in another embodiment, the coupling protrusion 160 may be disposed on an inner side or an outer side of the electrode terminals 131 and 132 based on the venting portion 140.

Hereinafter, the coupling hole 240 formed in the base 210 will be described.

The base 210 may include a plurality of coupling holes 240 formed at predetermined intervals in a longitudinal direction of the guide groove 220. The plurality of coupling holes 240 may be the first hole 241 or the second hole 242, and the first hole 241 and the second hole 242 may be alternately provided in the longitudinal direction of the guide groove 220.

A single battery cell 100 may be coupled and fixed to the base 210 through the first hole 241 and the second hole 242 adjacent to each other. For example, the cathode terminal 131 of the single battery cell 100 may be coupled to the first hole 241 in a state of being disposed to pass through the first hole 241, and the anode terminal 132 may be coupled to the second hole 242 in a state of being disposed to pass through the second hole 242 provided adjacent to the first hole 241, so that the single battery cell 100 may be fixed the base 210. Alternatively, a component coupled to the first hole 241 and the second hole 242 may be a coupling protrusion 160.

The venting portion 140 discharging gas generated inside the case 110 may be provided between the cathode terminal 131 and the anode terminal 132 in the single battery cell 100. Referring to FIG. 4, the first hole 241 may have a shape that is longer in a longitudinal direction (or X-direction) than the second hole 242, which may be to expose the venting portion 140 toward the bottom surface of the base 210. That is, the first hole 241 may have a shape extended in the X-direction by a length of the venting portion 140 more than the second hole 242. Additionally, accordingly, the gap between the first holes 241 and second holes 242 adjacent to each other may approximately match a gap between the venting portion 140 and the anode terminal 132 (or may be the cathode terminal 131) of the battery cell 100 or a gap between the venting portion 140 and the coupling protrusion 160.

Referring to FIG. 4, the first hole 241 and the second hole 242 may include a portion (hereinafter, the first portion) having a first width A1 and a portion (hereinafter, the second portion) having a second width A2 narrower than the first width A1. The first hole 241 and the second hole 242 may be disposed so that the second portion is in the same direction, e.g., in the +X-direction based on the drawing.

The width A1 of the first portion of the first hole 241 and the second hole 242 may be the same as the first width B1 of the electrode terminals 131 and 132 or may be greater than the first width B1 of the electrode terminals 131 and 132. Accordingly, the electrode terminals 131 and 132 may be inserted into the first hole 241 and the second hole 242 through the first portion.

The width A2 of the second portion of the first hole 241 and the second hole 242 may be approximately equal to the second width B2 of the separation protrusion 133, and may preferably be equal thereto. The separation protrusion 133 may be fitted into the first hole 241 and the second hole 242 in the second portion, and the battery cell 100 may be fixed to the base 210.

According to an embodiment of the present disclosure, as illustrated in FIG. 1, the busbar assembly 300 may be disposed below the cell fixing plate 200.

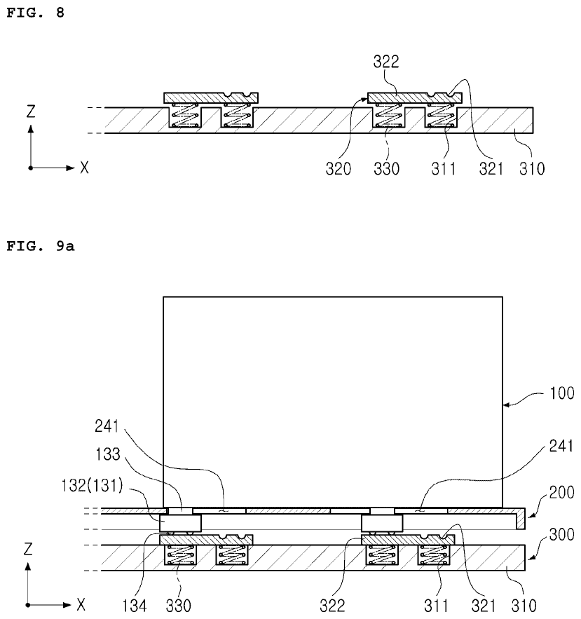

FIG. 8 is a side cross-sectional view of a busbar assembly according to an embodiment of the present disclosure.

Referring to FIG. 8, the busbar assembly 300 may include a busbar plate 310 and a busbar 320 arranged on the busbar plate 310.

The busbar plate 310 may be formed of a material having structural rigidity and insulating properties so as to support the battery cell 100.

A plurality of busbars 320 may be disposed on the busbar plate 310. In detail, the busbar 320 may be disposed on the busbar plate 310 in a state in which the busbar 320 is supported by a spring 330. The busbar plate 310 may include a spring groove 311 in which the spring 330 is disposed, and in an embodiment, the spring 330 may be a compression spring that is elastically deformable in a height direction (or Z-direction). A gap may be formed between the busbar 320 and the busbar plate 310 in the height direction (or Z-direction) by the spring 330.

The busbar 320 may be electrically connected to the electrode terminals 131 and 132 of the battery cell 100, and for this purpose, the busbar 320 may be disposed on the busbar plate 310 so as to face the electrode terminals 131 and 132 of the battery cell 100 in the height direction (or Z-direction). Each of the busbars 320 may face the cathode terminal 131 or the anode terminal 132 in the height direction (or Z-direction).

Meanwhile, as described above, the electrode terminals 131 and 132 may be electrically connected to the busbar 320 through a portion of the fitting protrusion 134. The busbar 320 may include a fitting groove 321 into which the fitting protrusion 134 of the electrode terminals 131 and 132 is inserted, and the fitting groove 321 may face the second portion to which the electrode terminals 131 and 132 is fixed in a height direction (or Z-direction). Additionally, the fitting groove 321 may be provided in a shape corresponding to the fitting protrusion 134 so that the fitting protrusion 134 may be inserted and fixed thereto, and the fitting groove 321 may be provided in a number and interval corresponding to the fitting protrusion 134. That is, according to an embodiment of the present disclosure, an electrical connection between the electrode terminals 131 and 132 of the battery cell 100 and the busbar 320 may be implemented in a form in which the fitting protrusion 134 is inserted into the fitting groove 321, and a welding process may be omitted.

Additionally, the busbar 320 may have a length in the longitudinal direction (or X-direction) for horizontal movement of the battery cell 100 when assembling the battery cell 100. For example, the busbar 320 may be in a form extending to one side of the fitting groove 321. Hereinafter, this portion is referred to as an extension portion 322, and the extension portion 322 may face the first portion of the coupling hole 240 in the height direction (or Z-direction).

Next, a method for assembling the battery cell 100 to the cell fixing plate 200 and the busbar assembly 300 will be described.

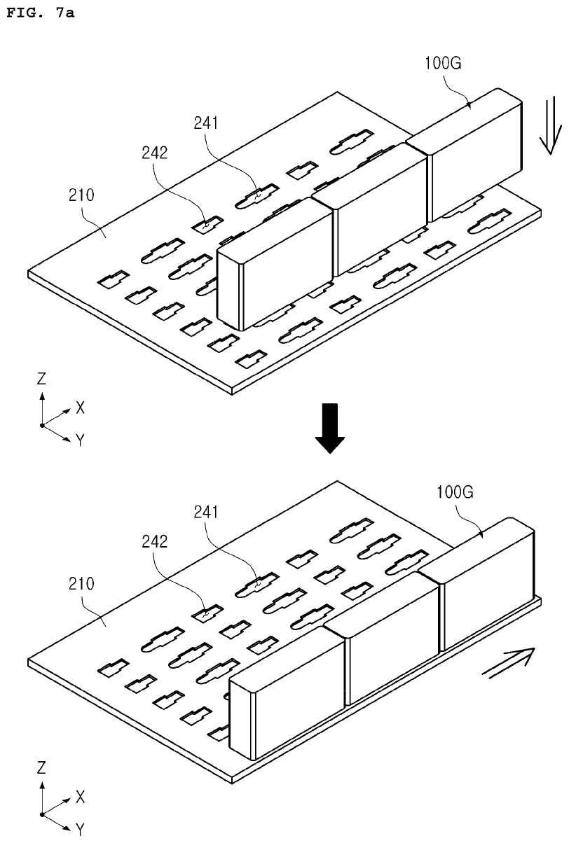

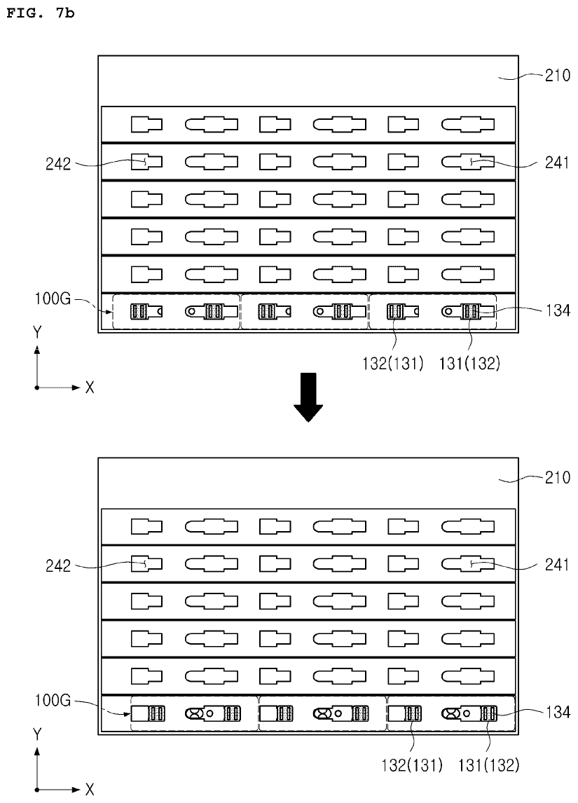

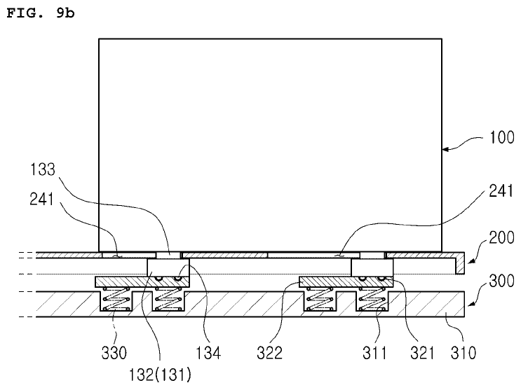

FIGS. 7A and 7B are views illustrating a method for assembling a battery cell to a cell fixing plate according to an embodiment of the present disclosure, and FIGS. 9A and 9B are view illustrating a method for assembling a battery cell to a busbar assembly according to an embodiment of the present disclosure.

According to an embodiment of the present disclosure, the battery cell 100 may be assembled to the cell fixing plate 200 through a vertical movement operation and a horizontal movement operation.

The battery cell 100 may be assembled in a cell group (100G) unit. In an embodiment, a plurality of battery cells 100 arranged in the longitudinal direction (or X-direction) may become one cell group 100G. Referring to FIGS. 7A and 7B, three battery cells 100 arranged in the longitudinal direction may become one cell group 100G. The one cell group 100G may be comprised of a number of battery cells 100 corresponding to the number of first hole 241 and second hole 242 provided along the guide groove 220.

The one cell group 100G may move vertically toward the base 210 (hereinafter, vertical movement operation). In the vertical movement operation, the one cell group 100G may be inserted into the coupling hole 240 formed in the base 210.

The one cell group 100G may be vertically moved from an upper side of the base 210 toward the base 210. The one cell group 100G may be vertically moved in a state in which the cathode terminals 131 and anode terminals 132 of the plurality of battery cells 100 are aligned to correspond to the first portions of the first hole 241 and the second hole 242, respectively. As described above, since the width A1 of the first portion of the first hole 241 and the second hole 242 is formed to be equal to the first width B1 of the electrode terminals 131 and 132 or greater than the first width B1 of the electrode terminals 131 and 132, the cathode terminal 131 and the anode terminal 132 may be inserted into the first hole 241 and the second hole 242 through the first portion, respectively, and may be disposed at the bottom surface of the base 210. In this case, the electrode terminals 131 and 132 may pass through the first portion, and the separation protrusion 133 may be disposed in the first portion, so that the one cell group 100G may be loosely coupled to the base 210.

The one cell group 100G may move horizontally in a state of being loosely coupled to the base 210. A horizontal movement direction may be the +X-direction based on the drawing, which may be a direction in which the first hole 241 and the second portion of the second hole 242 are disposed. That is, through the horizontal movement of the one cell group 100G, the separation protrusion 133 moves from the first portion to the second portion, and accordingly, a plurality of battery cells 100 may be fixed to the base 210.

Since the separation protrusion 133 is disposed in the first portion of the first hole 241 and the second hole 242 when the one cell group 100G is vertically moved, in order to fix the one cell group 100G to the base 210, it is necessary to move the separation protrusion 133 so that the separation protrusion 133 is disposed in the second portion of the first hole 241 and the second hole 242. Accordingly, the one cell group 100G may move horizontally in the +X-direction, so that the separation protrusion 133 may be disposed in the second portion. As described above, since the width A2 of the second portion of the first hole 241 and the second hole 242 is equal to the second width B2 of the separation protrusion 133, the battery cell 100 may be firmly fixed to the base 210 as the separation protrusion 133 moves from the first portion to the second portion. Additionally, as the one cell group 100G moves horizontally, the venting portion 140 may be exposed through the first hole 241.

Meanwhile, the cell fixing plate 200 may further include a fixing member (not illustrated) fixing the cell group 100G fixed to the base 210 through the vertical movement and horizontal movement. The fixing member may prevent the cell group 100G from moving in the-X-direction while being fixed to the base 210.

The fixing member may be fitted into the coupling hole 240 disposed on an opposite side (left side in the drawing) from the horizontal movement direction of the cell group 100G at the bottom surface of the base 210, e.g., the second hole 242 based on the drawing. In a state in which the cell group 100G is fixed to the base 210, the electrode terminals 131 and 132 and the separation protrusion 133 are disposed in the second portion, and the fixing member may be fitted into the first portion of the second hole 242.

The assembly operation illustrated in FIGS. 7A and 7B described above may be performed simultaneously with the assembly operation illustrated in FIGS. 9A and 9B. That is, the one cell group 100G may be fixedly connected to the cell fixing plate 200 and electrically connected to the busbar 320 of the busbar assembly 300 at the same time.

Referring to FIG. 9A, the busbar assembly 300 may be disposed below the cell fixing plate 200, and the one cell group 100G may pass through the coupling hole 240 formed in the base 210 in the vertical movement operation and may come into contact with the busbar assembly 300. In detail, in the vertical movement operation in which the one cell group 100G vertically moves toward the base 210, the electrode terminals 131 and 132 of the one cell group 100G may be inserted into the coupling hole 240 formed in the base 210 and exposed toward the busbar assembly 300 disposed below the base 210, so that the electrode terminals 131 and 132 may be placed on the busbar 320. When the one cell group 100G vertically moves, the electrode terminals 131 and 132 are inserted into the first portion having the first width A1 of the coupling hole 240, so that the electrode terminals 131 and 132 may be disposed in the extension portion 322 facing the first portion, and more specifically, the fitting protrusion 134 relatively protruding from one surface of the electrode terminals 131 and 132 may be disposed in the extension portion 322. Meanwhile, when the one cell group 100G vertically moves, the spring 330 supporting the busbar 320 may be compressed, and accordingly, a gap formed in the height direction (or Z-direction) between the busbar 320 and the busbar plate 310 formed by the spring 330 may disappear. That is, the busbar 320 may be closely attached to the busbar plate 310.

The one cell group 100G may be electrically connected to the busbar 320 in the horizontal movement operation. That is, the fitting protrusion 134 of the one cell group 100G may be inserted into the fitting groove 321 by horizontal movement. The one cell group 100G may be moved from the first portion to the second portion by horizontal movement, and the fitting protrusion 134 disposed on the busbar 320 may be moved from the extension portion 322 facing the first portion to the fitting groove 321 facing the second portion and may be inserted into the fitting groove 321. While the battery cell 100 is electrically connected to the busbar 320, the battery cell 100 may be fixed to the busbar 320. Meanwhile, as described above, since the fitting protrusion 134 has a semicircular cross-section, the fitting protrusion 134 may move horizontally while making point contact with the busbar 320, which may make it possible to perform smooth horizontal movement.

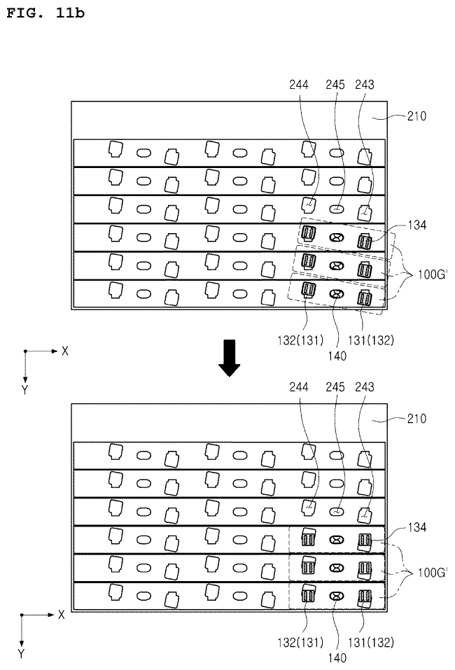

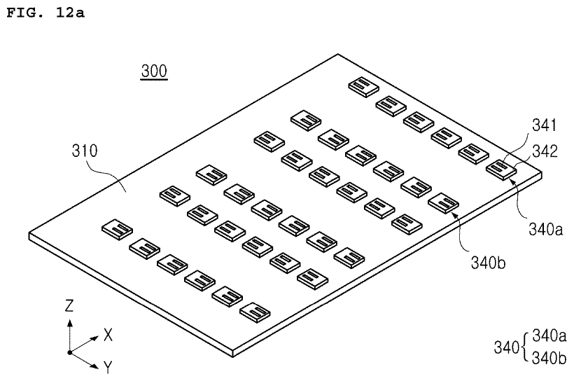

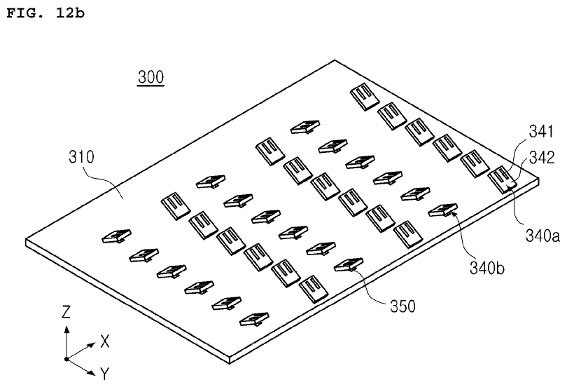

Additionally, FIGS. 11A and 11B are view illustrating a method for assembling a battery cell to a cell fixing plate according to another embodiment of the present disclosure, and FIGS. 12a and 12b are perspective views of a busbar assembly according to another embodiment of the present disclosure.

According to another embodiment of the present disclosure, the battery cell 100 may be assembled to the cell fixing plate 200 through a vertical movement operation and a horizontal rotation operation.

In the corresponding embodiment, the battery cell 100 may be assembled in a cell group (100G′) unit. However, a plurality of battery cells 100 forming the cell group 100G′ may be disposed approximately in the widthwise direction (or Y-direction). Referring to FIGS. 11A and 11B, three battery cells 100 arranged approximately in the widthwise direction may become one cell group 100G′. In this case, the three battery cells 100 may be arranged in a form tilted at a predetermined angle with respect to the longitudinal direction of the guide groove 220, and the coupling hole 240 may also be formed along the longitudinal direction of the guide groove 220 in a form tilted in the same direction as the battery cell 100.

Referring to FIGS. 11A and 11B, the coupling hole 240 may include first to third holes 243, 244 and 245. The cathode terminal 131, the anode terminal 132 and the venting portion 140 of the battery cell 100 may be coupled or exposed through the first hole 243, the second hole 244 and the third hole 245, respectively, and the first hole to the third hole 243, 244 and 245 may be alternately provided in the order of the first hole 243, the third hole 245 and the second hole 244 in the longitudinal direction of the guide groove 220.

In the case of the first hole 243 and the second hole 244 to which the electrode terminals 131 and 132 of the battery cell 100 are coupled, as in the above-described embodiment, the first hole 243 and the second hole 244 may include a first portion having a first width A1 and a second portion having a second width A2 narrower than the first width A1. However, the second portion of the first hole 243 and the second portion of the second hole 244 may be disposed in different directions. For example, the second portion of the first hole 243 may be disposed in the −Y-direction based on the drawing, and the second portion of the second hole 244 may be disposed in the +Y-direction based on the drawing. However, the present disclosure is not limited thereto, and a position of the second portion may vary depending on the horizontal rotation direction of the cell group 100G′.

Referring to FIGS. 11A and 11B, the one cell group 100G′ may move vertically toward the base 210, and the vertical movement operation may be the same as the embodiment illustrated in FIGS. 7A and 7B. Briefly, one cell group 100G′ may vertically move toward an upper surface of the base 210 in a state in which the cathode terminals 131 and the anode terminals 132 of the plurality of battery cells 100 are aligned to correspond to the first portions of the first hole 243 and the second hole 244, respectively. In a state in which the one cell group 100G′ moves vertically, the electrode terminals 131 and 132 may pass through the first portion, and the separation protrusion 133 may be disposed in the first portion.

The one cell group 100G′ may horizontally rotate in a state where the one cell group 100G′ is loosely coupled to the base 210. The horizontal rotation direction may be a counterclockwise direction based on the drawing, which may be a direction in which the second portions of the first hole 243 and the second hole 244 are disposed. That is, through the horizontal rotation of the one cell group 100G′, the separation protrusion 133 moves from the first portion to the second portion, and accordingly, a plurality of battery cells 100 may be fixed to the base 210. Additionally, as the one cell group 100G′ horizontally rotates, the venting portion 140 may be exposed entirely through the third hole 245.

According to an embodiment illustrated in FIGS. 11A and 11B, the cell group 100G′ may be aligned to be parallel to the longitudinal direction of the guide groove 220 through the horizontal rotation.

In another embodiment of the present disclosure, the one cell group 100G′ may be fixedly connected to the cell fixing plate 200 and may be electrically connected to the busbar 320 of the busbar assembly 300 at the same time. However, according to another embodiment of the present disclosure, since one cell group 100G′ undergoes the horizontal rotation operation after the vertical movement operation, the busbar assembly 300 may have a structure as illustrated in FIGS. 12A and 12B.

FIGS. 12A and 12B are perspective views of a busbar assembly according to another embodiment of the present disclosure.

Referring to FIGS. 12A and 12B, a plurality of busbars 340 may be disposed on a busbar plate 310. The plurality of busbars 340 may be disposed on the busbar plate 310 while being supported by a spring 350, and in an embodiment, the spring 350 may be a plate spring that is elastically deformable in an arc direction. A gap in the height direction (or Z-direction) may be formed between the busbar 340 and the busbar plate 310 by the spring 350.

The plurality of busbars 340 may have a length in the widthwise direction (or Y-direction) for horizontal rotation of the battery cell 100 when assembling the battery cell 100. That is, a fitting groove 341 and an extension portion 342 may be provided in the widthwise direction (or Y-direction).

Referring to FIGS. 12A and 12B, the plurality of busbars 340 may have the extension portion 342 provided on a side in the +Y-direction or −Y-direction based on the fitting groove 341. For example, the plurality of busbars 340 may include a first busbar 340a in which the extension portion 342 is provided on a side in the +Y-direction based on the fitting groove 341 and a second busbar 340b in which the extension portion 342 is provided on a side in the −Y-direction. The first busbar 340a and the second busbar 340b may be alternately disposed in the longitudinal direction (or X-direction) of the busbar plate 310, and may be electrically connected to the cathode terminal 131 or the anode terminal 132 of the battery cell 100 through the fitting protrusion 134, respectively. In other words, the one battery cell 100 may be electrically connected to the first busbar 340a and the second busbar 340b.

Meanwhile, in another embodiment, as illustrated in FIG. 12B, the first busbar 340a and the second busbar 340b may be disposed in a form inclined in different directions on the busbar plate 310. For example, the first busbar 340a may be disposed in a form inclined toward a side in the +Y-direction based on the drawing, and the second busbar 340b may be disposed in a form inclined toward a side in the −Y-direction based on the drawing.

According to another embodiment of the present disclosure, in the vertical movement operation, the electrode terminals 131 and 132 of the one cell group 100G′ may be inserted into the coupling hole 240 formed in the base 210 and may be exposed at the busbar assembly 300 disposed below the bottom of the base 210, and accordingly, the electrode terminals 131 and 132 may be disposed on the busbar 340. During the vertical movement, since the electrode terminals 131 and 132 are inserted into the first portion having the first width A1 of the coupling hole 240, the electrode terminals 131 and 132 and the fitting protrusions 134 formed in the electrode terminals 131 and 132 may be disposed in the extension portion 342 facing the first portion. Meanwhile, with the vertical movement of one cell group 100G′, the spring 350 supporting the busbar 340 may be compressed, so that the busbar 340 may be in close contact with the busbar plate 310.

The fitting protrusions 134 of the one cell group 100G′ may be inserted into the fitting groove 341 through the horizontal rotation. the one cell group 100G′ may move from the first portion to the second portion through the horizontal rotation, so that combination between the fitting protrusion 134 and the fitting groove 341 may be formed. Accordingly, the battery cell 100 may be electrically connected to the busbar 340 and may be fixed to the busbar 340.

As described above, according to embodiments of the present disclosure, the battery cell 100 may be simultaneously coupled to the cell fixing plate 200 and the busbar assembly 300. That is, since the battery cells 100 may be electrically connected to each other without undergoing a separate welding process, an assembly process may be simplified.

Although the configurations and characteristics of the present disclosure have been described based on the example embodiment of the present disclosure, the present disclosure is not limited thereto, and it is apparent to those skilled in the art to which the present disclosure belongs that various changes or modifications may be made within the concept and scope of the present disclosure, and thus it will be revealed that such changes or modifications fall within the appended claims.

1. A battery pack comprising:
a plurality of battery cells including electrode terminals on one side of a case;
a cell fixing plate to which the plurality of battery cells are coupled; and
a busbar assembly electrically connected to the plurality of battery cells,
wherein the cell fixing plate is disposed below the plurality of battery cells, and the busbar assembly is disposed below the cell fixing plate.

2. The battery pack of claim 1, wherein the busbar assembly includes:
a plurality of busbars electrically connected to the electrode terminals;
a busbar plate on which the plurality of busbars are disposed; and
a spring elastically supporting the plurality of busbars.

3. The battery pack of claim 2, wherein the busbar assembly includes:
a fitting groove to which the electrode terminal is coupled; and
an extension portion extending in a longitudinal direction or a widthwise direction of the busbar plate, based on the fitting groove.

4. The battery pack of claim 3, wherein the electrode terminal includes a fitting protrusion inserted into the fitting groove, and the plurality of battery cells are electrically connected to the plurality of busbars as the fitting protrusion is coupled to the fitting groove.

5. The battery pack of claim 4, wherein the fitting protrusion has a semicircular cross-sectional shape.

6. The battery pack of claim 2, wherein the spring is one of a compression spring or a plate spring.

7. The battery pack of claim 3, wherein the cell fixing plate includes:
a base; and
a plurality of coupling holes formed in the base, and including a first hole into which a cathode terminal, among the electrode terminals, is inserted, and a second hole into which an anode terminal, among the electrode terminals, is inserted,
wherein the first hole and the second hole include a first portion having a first width and a second portion having a second width narrower than the first width.

8. The battery pack of claim 7, wherein the busbar assembly is disposed so that the extension portion faces the first portion and the fitting groove faces the second portion.

9. The battery pack of claim 7, wherein the plurality of battery cells include a cap plate coupled to one side of the case and provided with the electrode terminal; and
a separation protrusion separating one surface of the electrode terminal from the cap plate,
wherein the electrode terminal is formed to have a width not wider than the first width, and the separation protrusion is formed to have a width equal to the second width.

10. The battery pack of claim 7, wherein the plurality of battery cells include a cap plate coupled to one side of the case and provided with the electrode terminal; and
a coupling protrusion formed on one side of the cathode terminal and one side of the anode terminal, respectively, and penetrating through the first hole and the second hole, and
wherein the coupling protrusion includes a portion formed to have a width not wider than the first width and a portion formed to have a width equal to the second width.

11. A busbar assembly, comprising:
a plurality of busbars disposed at a bottom plate of the pack housing, and electrically connected to electrode terminals of a plurality of battery cells;
a busbar plate on which the plurality of busbars are disposed; and
a spring elastically supporting the plurality of busbars.

12. The busbar assembly of claim 11, wherein the plurality of busbars include:
a fitting groove to which the electrode terminal is fitted; and
an extension portion extending in a longitudinal direction or a widthwise direction of the busbar plate based on the fitting groove.

13. An assembling method for battery cells, the method comprising:
a vertical movement operation of vertically moving a cell group comprised of a plurality of battery cells toward a cell fixing plate and a busbar assembly disposed below the cell fixing plate and including a plurality of busbars; and
a horizontal movement operation of horizontally moving or rotating the cell group on the cell fixing plate and the busbar assembly so that the plurality of battery cells are fixed to the cell fixing plate and the busbar assembly.

14. The assembling method for battery cells of claim 13, wherein the electrode terminal includes a fitting protrusion, and the plurality of busbars include a fitting groove having a shape corresponding to the fitting protrusion, and in the horizontal movement operation, the fitting protrusion is inserted into the fitting groove.

15. The assembling method for battery cells of claim 14, wherein the cell fixing plate includes a plurality of coupling holes into which the electrode terminal is inserted, and which include a first portion having a first width and a second portion having a second width narrower than the first width, and
in the horizontal movement operation, the electrode terminal is moved from the first portion side to the second portion side.

16. The assembling method for battery cells of claim 15, wherein the battery cell includes:
a cap plate coupled to one side of the case and provided with the electrode terminal; and
a separation protrusion separating one surface of the electrode terminal from the cap plate,
wherein the electrode terminal is formed to have a width not wider than the first width, and the separation protrusion is formed to have a width equal to the second width.

17. The assembling method for battery cells of claim 15, wherein the plurality of busbars include an extension portion extending to one side based on the fitting groove, and
the extension portion is disposed to face the first portion, and the fitting groove is disposed to face the second portion.

18. The assembling method for battery cells of claim 15, wherein, when the second portion of the first hole and the second portion of the second hole are formed to be oriented in the same direction, and the fitting grooves of the busbar are formed to be oriented in the same direction, in the horizontal movement operation, the cell group is moved in parallel on the cell fixing plate and the busbar assembly.

19. The assembling method for battery cells of claim 15, wherein, when the second portion of the first hole and the second portion of the second hole are formed to be oriented in different directions, and the busbar facing the first hole and the busbar facing the second hole are disposed to be oriented in different directions, in the horizontal movement operation, the cell group is rotated on the cell fixing plate and the busbar assembly.
